(19) United States
(12) Patent Application Publication
(10) Pub. No.: US 2013/0152895 A1
(43) Pub. Date: Jun. 20, 2013

(54) INTAKE APPARATUS FOR INTERNAL COMBUSTION ENGINE

(71) Applicant: Mahle Filter Systems Japan Corporation, Tokyo (JP)

(72) Inventor: Yuji YASUDA, Tokyo (JP)

(73) Assignee: MAHLE FILTER SYSTEM JAPAN CORPORATION, Tokyo (JP)

(21) Appl. No.: 13/676,833

(22) Filed: Nov. 14, 2012

(30) Foreign Application Priority Data
Dec. 16, 2011 (JP) 2011-275160

(51) Int. Cl. F02M 35/12

(52) U.S. Cl. CPC F02M 35/1222; F02M 35/1227
USPC 123/184.54

(57) ABSTRACT

An intake apparatus including two intake ducts and a flap mechanism disposed in one of the two intake ducts, the flap mechanism including a main flap, a damper flap, a damper chamber cooperating with the damper flap to form a damper space, and a biasing member biasing the main flap in a closing direction. When the main flap is located in an angular range between the fully closing position and a predetermined opening angle, a peripheral edge of the damper flap is opposed to an inner wall surface of the damper chamber with a fine clearance to thereby render the damper space substantially closed. When the main flap is located with an opening angle larger than the predetermined opening angle, a communication passage to open the damper space is formed between the inner wall surface of the damper chamber and the peripheral edge of the damper flap.

### BACKGROUND OF THE INVENTION

The present invention relates to an intake apparatus for an internal combustion engine for a vehicle such as an automobile, and particularly, to an intake apparatus adapted to carry out changeover of an effective cross-sectional area of a passage on the side of an intake inlet of an air cleaner depending upon an intake air flow rate.

It is generally known that in an internal combustion engine for a vehicle such as an automobile, in a case where a cross-sectional area of a passage of an intake duct as an intake inlet of an intake system which is opened to an outside is large, noise leaking from the intake inlet becomes large. In contrast, in a case where the cross-sectional area of the passage is too small, when an intake air flow rate is large, an air flow resistance is increased so that air intake efficiency is deteriorated.

From the above viewpoint, there have been proposed various kinds of technologies of varying an effective cross-sectional area of a passage on the side of an intake inlet of an air cleaner depending upon an intake air flow rate. For instance, Japanese Patent Application Unexamined Publication No. 2000-54924 discloses an intake duct including first and second intake passages (as an intake duct) arranged parallel to each other, and a flap valve disposed in the second intake passage. The flap valve is biased toward a closing direction thereof by a biasing member such as a spring, a weight or the like. The flap valve is moved to an opening state and a closing state by a balance between a biasing force of the biasing member in the closing direction and a force acting on the flap valve in an opening direction due to a pressure difference between an upstream side of the flap valve and a downstream side of the flap valve. The flap valve is held in the closing state in a low speed range of the internal combustion engine in which an intake air flow rate is small. The flap valve is moved to the opening state in a high speed range of the internal combustion engine in which an intake air flow rate is large. Owing to the movement of the flap valve, an effective cross-sectional area of the passage is varied in two stages. That is, the intake duct of the conventional art is constructed such that the flap valve is automatically moved to the opening state and the closing state in response to an intake air flow without using a control device or an actuator.

### SUMMARY OF THE INVENTION

In the intake duct of the above-described conventional art in which the flap valve is opened by the force due to the intake air flow, the flap valve is held in the fully closing state by the biasing member such as a spring in the low speed range of the internal combustion engine. Due to such a construction, there is a problem that the flap valve held in the fully closing state is caused to vibrate due to pulsation of the intake air, vibration of a vehicle during running, and the like. Particularly, when the engine rotation speed is in the vicinity of a set rotation speed at which the flap valve begins to move toward the opening position, slight or fine movement of the flap valve in the opening direction and the closing direction is repeated in response to the pulsation of the intake air, so that noise occurs due to impingement of a tip end of the flap valve against an inner wall surface of the intake passage.

Further, the above-described conventional art also discloses that the flap valve is held in the fully closing state by a magnetic force of a permanent magnet. However, in such a construction using a magnetic force of the permanent magnet in addition to the biasing force of the spring, an opening movement of the flap valve is excessively disturbed to thereby make it difficult to obtain a smoothly opening movement of the flap valve at a desired set rotation speed.

In a first aspect of the present invention, there is provided an intake apparatus for an internal combustion engine equipped with an air cleaner, including:

two intake ducts connected to an intake inlet of the air cleaner; and

a flap mechanism disposed in one of the two intake ducts, the flap mechanism serving for opening and closing the one of the two intake ducts in response to intake air flow entering into the one of the two intake ducts,

the flap mechanism including:

a plate-shaped main flap supported at one end portion thereof so as to be rotatable about a rotation axis between a fully opening position and a fully closing position, the rotation axis being located at the one end portion of the main flap,

a plate-shaped damper flap disposed to make a predetermined angle between the main flap and the damper flap with respect to the rotation axis, the damper flap making a unitary rotation with the main flap,

a damper chamber formed in a portion of an outer wall of the one of the two intake ducts so as to be recessed along a trace of rotational movement of the damper flap, the damper chamber cooperating with the damper flap to form a damper space therebetween, and

a biasing member that biases the main flap in a closing direction;

wherein when the main flap is located in an angular range between the fully closing position and a predetermined opening angle, a peripheral edge of the damper flap is opposed to an inner wall surface of the damper chamber with a fine clearance so that the damper space is rendered substantially closed, and

when the main flap is located with an opening angle larger than the predetermined opening angle, a communication passage that serves to open the damper space is formed between the inner wall surface of the damper chamber and the peripheral edge of the damper flap.

In the above construction of the intake apparatus of the present invention, the main flap and the damper flap make a unitary rotation in response to an intake air flow. In a low speed range of the engine in which an intake air flow rate is small, the main flap is held in the fully closing position in which one of the intake air passages is blocked by a biasing force of the biasing member such as a spring or a weight. At this time, when vibration of the main flap is caused due to pulsation of the intake air, vibration of the vehicle during running, and the like, the damper flap formed integrally with the main flap is vibrated within the damper chamber. In the vicinity of the fully closing position of the main flap, a peripheral edge of the damper flap is located close to an inner wall surface of the damper chamber with a fine clearance, so that the damper space is rendered substantially closed. As a result, vibration of the damper flap and vibration of the main flap can be suppressed. That is, the damper flap and the damper chamber constitute a kind of air damper to thereby suppress vibration of the main flap in the vicinity of the fully closing position of the main flap and generation of noise.

On the other hand, when the intake air flow rate is increased to a predetermined level, the main flap is started to move toward the opening position against a biasing force of the biasing members such as a spring. At this time, the damper constituted of the damper flap and the damper chamber provides a slight resistance as a damper until the opening angle reaches a predetermined opening angle. When the main flap is rotated to exceed the predetermined opening angle so that the damper flap is moved into the damper chamber, the damper space is opened through the communication passage to thereby lose the resistance as the damper. Accordingly, the main flap is immediately rotationally moved to the fully opening position together with the damper flap.

In a second aspect of the present invention, there is provided the intake apparatus according to the first aspect, wherein the inner wall surface of the damper chamber includes a peripheral inner-wall surface that is configured to be opposed to a tip end edge of the damper flap with a fine clearance in the angular range between the fully closing position of the main flap and the predetermined opening angle, and be retreated toward an outer peripheral side of the damper chamber to be spaced apart from the tip end edge of the damper flap in an angular range larger than the predetermined opening angle to thereby form the communication passage.

That is, in the vicinity of the fully closing position of the main flap, the tip end edge of the damper flap is located close to the peripheral inner wall surface of the damper chamber with a fine clearance, so that the damper space is retained as a substantially closed space. When the main flap is rotated to exceed the predetermined opening angle, there is generated a large clearance between the tip end edge of the damper flap and the peripheral inner wall surface of the damper chamber is generated so that the damper space is opened.

In a third aspect of the present invention, there is provided the intake apparatus according to the first aspect, wherein the damper chamber has an opening through which the damper chamber is communicated with the intake passage in the one of the two intake ducts, and when the main flap is located in the fully opening position, the main flap closes the opening of the damper chamber.

The intake apparatus for an internal combustion engine according to the present invention can attain the effects as follows. It is possible to vary an effective cross-sectional area of a passage on the side of an intake inlet of an air cleaner, thereby serving to reduce intake noise in a low speed range of the engine and ensure air intake efficiency. Further, when the main flap is located in the vicinity of the fully closing position, vibration of the main flap due to intake pulsation, etc. can be effectively suppressed by a damping function. When the main flap is moved toward the opening position as the intake air flow rate is increased, the damping function is lost when reaching a predetermined opening angle so that the main flap is allowed to immediately open. Accordingly, it is possible to prevent occurrence of noise due to vibration of the main flap, and avoid deterioration in acceleration performance owing to delay in opening movement of a flap mechanism.

### BRIEF DESCRIPTION OF THE DRAWINGS

FIG. 1 is an explanatory diagram schematically showing a construction of a whole intake apparatus according to an embodiment of the present invention.

FIG. 2 is a partially cut-out side view of a secondary duct of the intake apparatus according to the embodiment of the present invention, showing a flap mechanism in the secondary duct.

FIG. 3 is a cross-sectional view of the secondary duct of the intake apparatus according to the embodiment of the present invention, showing the flap mechanism when viewed from a front side thereof.

FIG. 4 is a perspective view of a flap valve of the flap mechanism as shown in FIG. 3.

FIG. 5 is a perspective view of a damper casing portion of the secondary duct when viewed from an outside.

FIG. 6 is an explanatory diagram showing the flap valve moving to an opening position thereof.

FIG. 7 is an explanatory diagram showing the flap valve located in a fully opening position thereof.

### DETAILED DESCRIPTION OF THE INVENTION

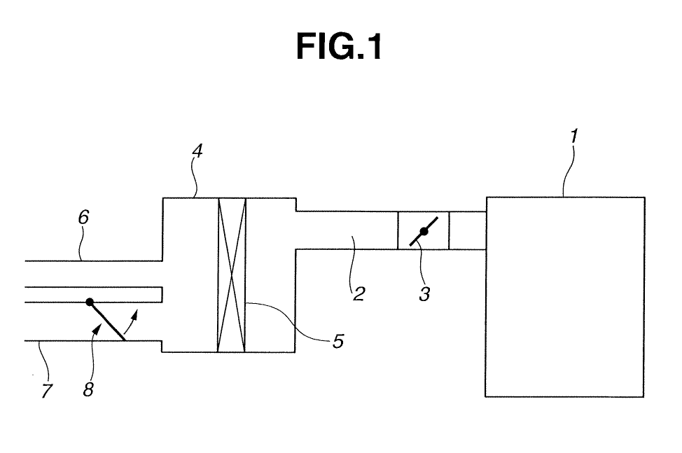

Referring to FIGS. 1-7, an intake apparatus for an internal combustion engine according to an embodiment of the present invention will be explained in detail hereinafter. FIG. 1 is an explanatory diagram schematically showing a construction of the whole intake apparatus for an internal combustion engine 1 according to an embodiment of the present invention. As shown in FIG. 1, an intake path 2 is connected to the internal combustion engine 1 (e.g., as a gasoline engine) through an intake collector (not shown). The intake path 2 includes a throttle valve 3, and is connected with an air cleaner 4 at one end thereof. The air cleaner 4 includes an air cleaner element 5, so that an interior space of the air cleaner 4 is divided into a dust side and a clean side by the air cleaner element 5. Connected to the dust side are a primary duct 6 and a secondary duct 7 which serve as an intake inlet of the air cleaner 4. The primary duct 6 and the secondary duct 7 are arranged parallel to each other, and have tip ends which are opened to an outside to thereby serve as an outside air intake. One of these ducts 6 and 7, for example, the secondary duct 7 in this embodiment, is provided with a flap mechanism 8 serving for opening and closing the secondary duct V. The flap mechanism 8 is basically constructed such that in a low speed range of the engine in which an intake air flow rate is small, a flap valve 13 as explained later is held in a closing position to thereby reduce intake noise leaking outside, and in a high speed range of the engine in which the intake air flow rate is large, the flap valve 13 is held in an opening position to thereby ensure a necessary cross-sectional area of an air passage in the intake apparatus.

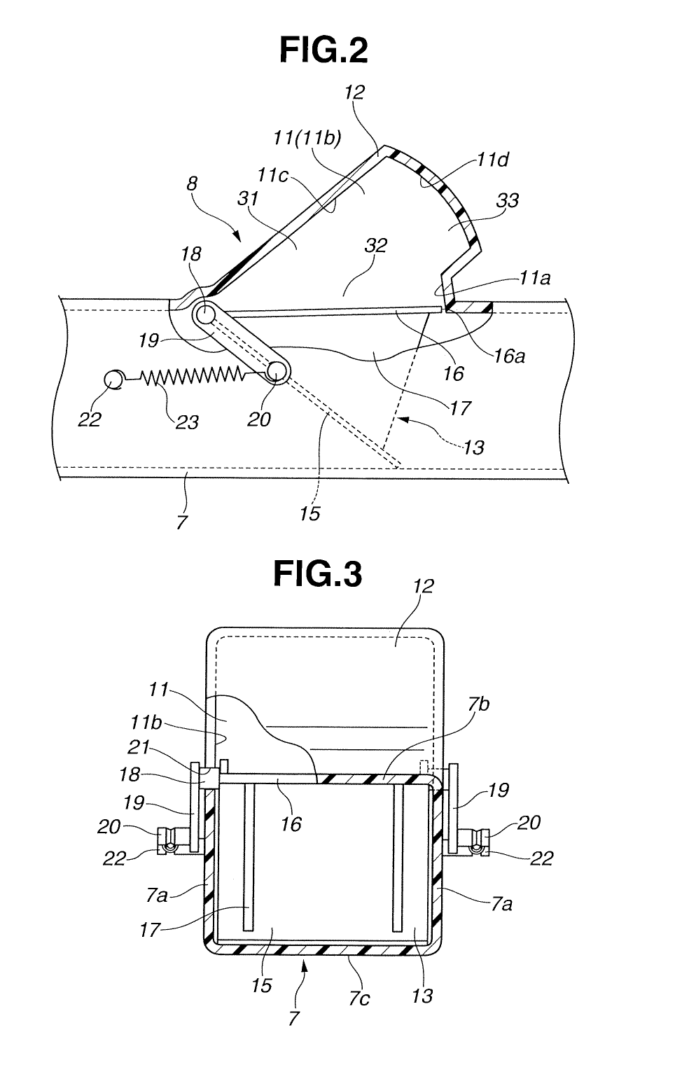

FIG. 2 is a side view of the secondary duct 7 partially cut out, and shows a cross section of a part of the flap mechanism 8. FIG. 3 is a cross-sectional view of a part of the secondary duct 7 in which the flap mechanism 8 is provided. As shown in FIG. 3, the secondary duct 7 has a rectangular shape in cross section and includes a pair of left and right side walls 7a, 7a, an upper wall 7b, and a bottom wall 7c. A damper casing portion 12 as an outer wall of the secondary duct 7 is formed to upwardly bulge from an upper surface of the upper wall 7b, which defines a damper chamber 11 (see FIG. 2) therein. As shown in FIG. 2, the flap valve 13 that constitutes the flap mechanism 8 is disposed in a position corresponding to the damper casing portion 12.

In FIG. 2, similarly to FIG. 1, the left side and the right side denote a side of the intake inlet and a side of the air cleaner 4, respectively, and an intake air flows from the left side toward the right side. Further, in a condition that the intake apparatus is mounted to a vehicle, the flap mechanism 8 is not always in the posture as shown in FIG. 2 and FIG. 3. However, in the following, for the sake of assisting in comprehension, positional or directional terms such as up, down, left, right, clockwise, counterclockwise, etc. are used with reference to the posture of FIG. 2.

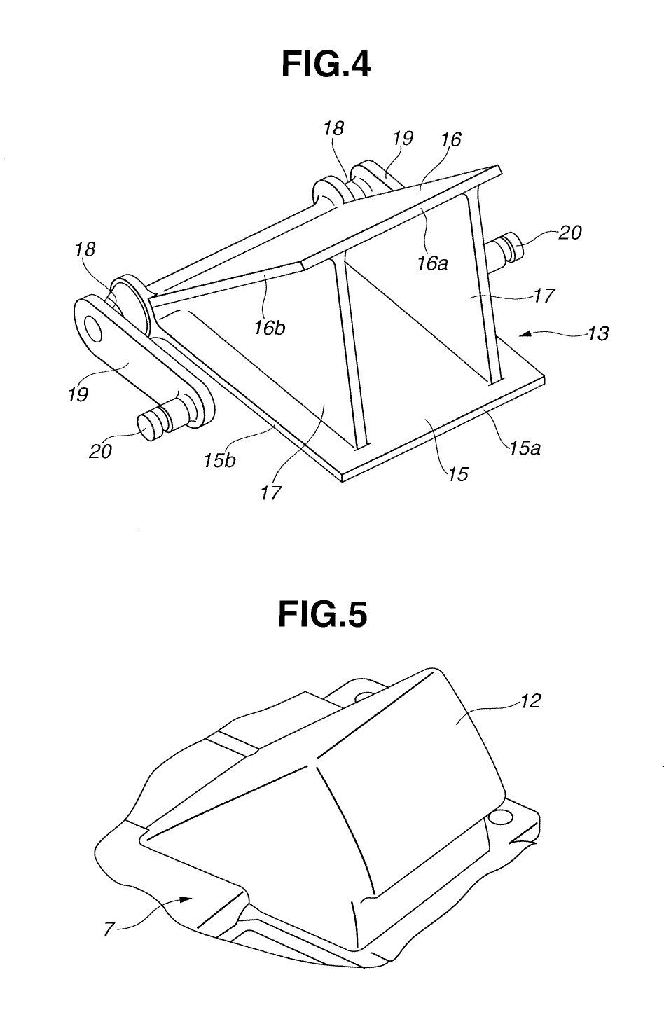

As shown in FIG. 2 and FIG. 4, the flap valve 13 includes a main flap 15 having a rectangular plate shape, and a damper flap 16 also having a rectangular plate shape. These two flaps 15, 16 are connected to each other at one end portions thereof so as to form a V-shape in side view. A pair of triangular side walls 17, 17 are disposed between the flaps 15, 16, and connect the flaps 15, 16 with each other. A pair of rotation shaft portions 18 are disposed on both sides of a connecting portion in which the one end portions of the flaps 15, 16 are connected to each other, and project outwardly from the both sides, respectively. The rotation shaft portions 18 cooperate with each other to provide a rotation axis about which the flap valve 13 is rotatable. The rotation shaft portions 18 have tip ends to which root end portions of a pair of arms 19 are connected, respectively. These arms 19 extend parallel to left and right side edges 15b of the main flap 15, respectively. Pins 20 are respectively disposed on tip end portions of the arms 19, and project leftward and rightward from the tip end portions of the arms 19. The rotation shaft portions 18 are rotatably fitted into bearing holes 21 respectively formed in the left and right side walls 7a, 7a of the secondary duct 7 as shown in FIG. 3. Specifically, the bearing holes 21 are respectively formed in upper portions of the side walls 7a, 7a which are in the vicinity of the upper wall 7b of the secondary duct 7. With this construction, the flap valve 13 as a whole is supported so as to be rotatable about the rotation axis of the rotation shaft portions 18.

The arms 19 are located on an outside of the side walls 7a, 7a of the secondary duct 7. A tension coil spring 23 as a biasing member is disposed between each of the pins 20 disposed on the tip end portions of the arms 19 and each of pins 22 disposed on the side walls 7a, 7a. The coil spring 23 is disposed along a longitudinal direction of the secondary duct 7 to expand in its length as an opening angle of the main flap 15 is increased. With this construction, the whole flap valve 13 is urged in a clockwise direction as viewed in FIG. 2, i.e., in a closing direction of the main flap 15 by a tensile force of the coil spring 23. A resilient member other than the coil spring, gravity of a weight, or the like may be used as the biasing member.

The main flap 15 has a rectangular plate shape corresponding to a rectangular shape of the cross section of the secondary duct 7. As shown in FIG. 2, when the main flap 15 is held in a closing position in which the main flap 15 is in such an inclined state as to extend from the rotation shaft portions 18 toward a downstream side of the intake air flow. The damper flap 16 is located above the main flap 15, and has a rectangular plate shape similarly to that of the main flap 15. In this embodiment, the damper flap 16 has a width extending between left and right side edges 16b in a direction parallel to the rotation axis which is equal to a width of the main flap 15 extending between the left and right side edges 15b in the direction parallel to the rotation axis. The damper flap 16 has a length between the one end portion thereof and a tip end edge 16a in a direction perpendicular to the rotation axis which is slightly shorter than a length between the one end portion thereof and a tip end edge 15a of the main flap 15 in the direction perpendicular to the rotation axis. However, a shape of the main flap 15 and the damper flap 16 and a dimensional relationship between the main flap 15 and the damper flap 16 is not limited to this embodiment, and may be optionally determined. An angle formed between the main flap 15 and the damper flap 16, i.e., a vertex angle of the V-shaped flap valve 13, is set depending on an inclination angle of the main flap 15 in the fully closing position thereof. The angle is set such that when the main flap 15 is in the fully closing position, the damper flap 16 is located parallel to the upper wall 7b or the bottom wall 7c of the secondary duct 7.

The flap valve 13 is made of a synthetic resin material, and formed as an integral part as shown in FIG. 4.

The damper chamber 11 is defined by the damper casing portion 12 formed to upwardly bulge from the upper surface of the upper wall 7b of the secondary duct 7 as shown in FIG. 5. The damper chamber 11 is upwardly recessed when viewed from an inside of an intake passage in the secondary duct 7. The damper chamber 11 is configured along a trace of rotational movement of the damper flap 16 so as to permit the damper flap 16 to enter into the damper chamber 11 when the flap valve 13 is rotationally moved in the opening direction. Specifically, the damper chamber 11 has an inner wall including a pair of left and right side inner-wall surfaces 11b, a peripheral inner-wall surface 11a, and an inclined top inner-wall surface 11c. The side inner-wall surfaces 11b are planar surfaces formed along a trace of rotational movement of the left and right side edges 16b of the damper flap 16 (see FIG. 4). The peripheral inner-wall surface 11a is a partially cylindrical surface formed along a trace of rotational movement of the tip end edge 16a of the damper flap 16. The inclined top inner-wall surface 11c is a planar surface inclined with an inclination angle corresponding to the vertex angle of the flap valve 13. A damper space 31 is defined between the inclined top inner-wall surface 11c and the damper flap 16. Further, the damper chamber 11 recessed when viewed from the inside of the intake passage in the secondary duct 7 is communicated with the intake passage in the secondary duct 7 through an opening 32 having a rectangular shape in plan view. The opening 32 is substantially closed by the damper flap 16 when the main flap is in the fully closing position as shown in FIG. 2. In this state, only a fine clearance exists between the side edges 16b of the damper flap 16 and the side inner-wall surfaces 11b of the damper chamber 11, and between the tip end edge 16a of the damper flap 16 and the peripheral inner-wall surface 11a of the damper chamber 11. Accordingly, the damper space 31 is rendered substantially closed.

Further, the arcuate peripheral inner-wall surface 11a of the damper chamber 11 which is opposed to the tip end edge 16a of the damper flap 16 with the fine clearance is formed only in a relatively small angular range extending upwardly from the opening 32. An increased-diameter inner-wall surface 11d is formed on an upper side of the angular range of the peripheral inner-wall surface 11a, and located in a position retreated toward an outer peripheral side of the damper chamber 11 with respect to the arcuate trace of rotational movement of the tip end edge 16a of the damper flap 16. That is, the increased-diameter inner-wall surface 11d is located spaced apart from the arcuate trace of rotational movement of the tip end edge 16a of the damper flap 16 with a sufficiently large gap. In this state, a communication passage 33 that serves to open the damper space 31 and communicate the damper space 31 with the intake passage in the secondary duct 7 is formed over a whole width of the damper flap 16. In this embodiment, the increased-diameter inner-wall surface 11d is also formed into a partially cylindrical shape having a diameter larger than that of the peripheral inner-wall surface 11a. However, since the increased-diameter inner-wall surface 11d is spaced apart from the tip end edge 16a of the damper flap 16, the shape of the increased-diameter inner-wall surface 11d may be optionally determined without being limited to the partially cylindrical shape in this embodiment.

A boundary between the peripheral inner-wall surface 11a coming close to the tip end edge 16a of the damper flap 16 and the increased-diameter inner-wall surface 11d relatively farther spaced from the tip end edge 16a is located within an angular range corresponding to a predetermined opening angle of the main flap 15 which is necessary to suppress vibration or fluttering of the main flap 15. The angular range is set to, for example, about 10 degrees to 20 degrees, but is not limited to this range.

An operation of the thus constructed intake apparatus according to the embodiment will be explained hereinafter. In an engine low speed range in which the intake air flow rate of the internal combustion engine 1 is lower than a predetermined level, the damper flap 16 as a whole is urged in the clockwise direction in FIG. 2 by the tensile force of the coil spring 23, and the main flap 15 is held in the fully closing position as shown in FIG. 2. At this time, the damper flap 16 is located in the opening 32 of the damper chamber 11, and retains the damper space 31 as the substantially closed space. When the main flap 15 is caused to move due to pulsation of the intake air, vibration of the vehicle during running, or the like, the damper flap 16 tends to move in accordance with the movement of the main flap 15, so that air within the damper space 31 is permitted to flow through the fine clearance around the damper flap 16, thereby obtaining a function of damping with respect to the movement of the damper flap 16. As a result, it is possible to suppress vibration and fluttering of the main flap 15 in the vicinity of the fully closing position and therefore, suppress occurrence of noise due to impingement of the main flap 15 against the walls of the secondary duct 7.

When the intake air flow rate is increased to the predetermined level, the main flap 15 starts to rotationally move in the opening direction against the tensile force of the coil spring 23 by the force of the intake air flow. The damper flap 16 and the damper chamber 11 which constitute a damper provide a slight resistance until the tip end edge 16a of the damper flap 16 passes over the peripheral inner-wall surface 11a of the damper chamber 11, namely, until the damper flap 16 is rotated by a predetermined opening angle.

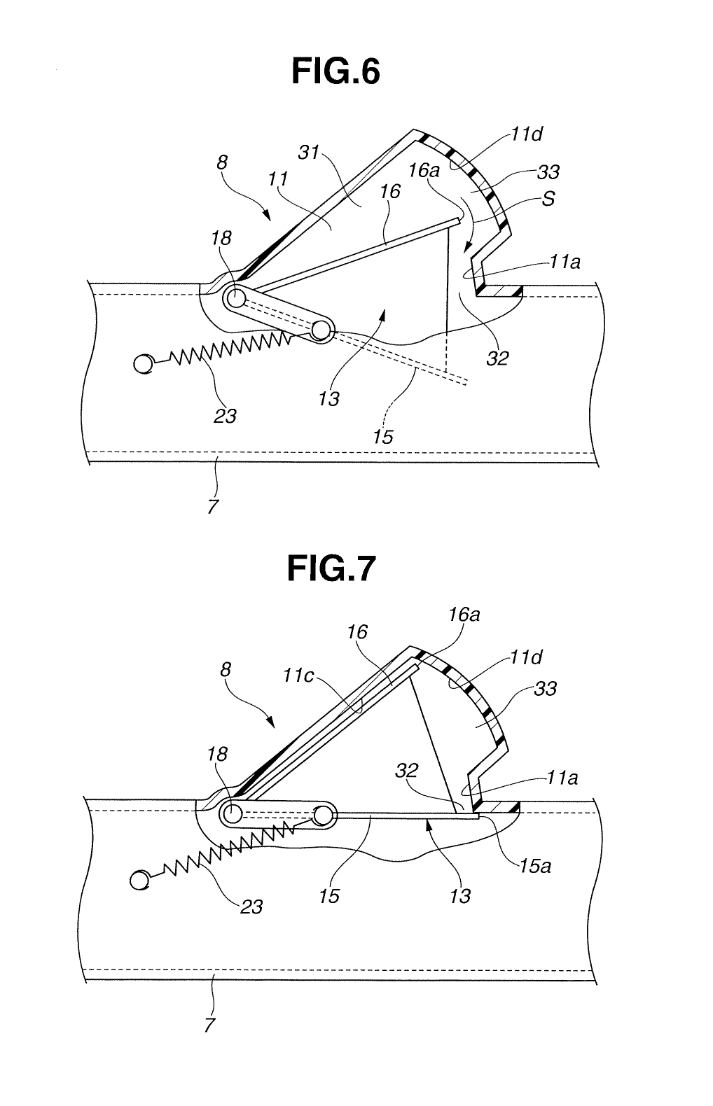

When the damper flap 16 is further rotated beyond the predetermined opening angle and the tip end edge 16a of the damper flap 16 approaches the increased-diameter inner-wall surface 11d of the damper chamber 11, air is escaped from the damper space 31 through the communication passage 33 between the tip end edge 16a of the damper flap 16 and the increased-diameter inner-wall surface 11d as indicated by arrow S in FIG. 6. That is, when the main flap is located with an opening angle larger than the predetermined opening angle, the damper space 31 is opened, so that the resistance provided by the damper disappears. Accordingly, the main flap 15 and the damper flap 16 immediately make a unitary rotation, and the main flap 15 is moved to a fully opening position.

Owing to the above-described operation, upon shifting the internal combustion engine 1 from an idling state to an acceleration state, the main flap 15 is allowed to immediately move to the fully opening position in response to increase in the intake air flow rate. As a result, it is possible to surely avoid deterioration in acceleration performance which is caused due to a delay in the opening movement of the main flap 15.

FIG. 7 shows the main flap 15 located in the fully opening position in which the secondary duct 7 is opened. In the fully opening position as shown in FIG. 7, the damper flap 16 is disposed close to the inclined top inner-wall surface 11c of the damper chamber 11, and the main flap 15 is contacted with a peripheral edge of the opening 32 of the damper chamber 11 to thereby close the opening 32. Specifically, in this embodiment, the main flap 15 is slightly longer than the damper flap 16, and therefore, a peripheral portion along the tip end edge 15a of the main flap 15 is overlapped with the peripheral edge of the opening 32. The overlapping peripheral portion of the main flap 15 serves as a stop. Thus, the main flap 15 closes the opening 32, and extends along the upper wall 7b of the secondary duct 7 in parallel with the intake air flow in the secondary duct 7. With this arrangement, the intake air flow in the secondary duct 7 can be smoothened, thereby suppressing increase in intake resistance.

The present invention is not limited to the above-described embodiment, and various modifications thereof may be provided. For example, although in this embodiment, the communication passage 33 is defined by the increased-diameter inner-wall surface 11d so as to extend over the whole width of the damper flap 16, the communication passage can also be formed by a grooved portion on the inner-wall surface of the damper chamber 11 which is opposed only to a part of the tip end edge 16a of the damper flap 16 in the width direction when the main flap 15 is rotationally moved in the opening direction together with the damper flap 16. Further, the communication passage can be formed by a grooved portion on the side inner-wall surfaces 11b of the damper chamber 11 which are opposed to the side edges 16b of the damper flap 16 when the main flap 15 is rotationally moved in the opening direction together with the damper flap 16.

This application is based on a prior Japanese Patent Application No. 2011-275160 filed on Dec. 16, 2012. The entire contents of the Japanese Patent Application No. 2011-275160 are hereby incorporated by reference.

Although the invention has been described above by reference to a certain embodiment of the invention and modifications thereof, the invention is not limited to the embodiment and the modifications as described above. Variations of the embodiment and the modifications as described above will occur to those skilled in the art in light of the above teachings. The scope of the invention is defined with reference to the following claims.

What is claimed is:

1. An intake apparatus for an internal combustion engine equipped with an air cleaner, comprising:
two intake ducts connected to an intake inlet of the air cleaner; and
a flap mechanism disposed in one of the two intake ducts, the flap mechanism serving for opening and closing the one of the two intake ducts in response to intake air flow entering into the one of the two intake ducts,
the flap mechanism comprising:
a plate-shaped main flap supported at one end portion thereof so as to be rotatable about a rotation axis between a fully opening position and a fully closing position, the rotation axis being located at the one end portion of the main flap,
a plate-shaped damper flap disposed to make a predetermined angle between the main flap and the damper flap with respect to the rotation axis, the damper flap making a unitary rotation with the main flap,
a damper chamber formed in a portion of an outer wall of the one of the two intake ducts so as to be recessed along a trace of rotational movement of the damper flap, the damper chamber cooperating with the damper flap to form a damper space therebetween, and
a biasing member that biases the main flap in a closing direction;
wherein when the main flap is located in an angular range between the fully closing position and a predetermined opening angle, a peripheral edge of the damper flap is opposed to an inner wall surface of the damper chamber with a fine clearance so that the damper space is rendered substantially closed, and
when the main flap is located with an opening angle larger than the predetermined opening angle, a communication passage that serves to open the damper space is formed between the inner wall surface of the damper chamber and the peripheral edge of the damper flap.

2. The intake apparatus as claimed in claim 1, wherein the inner wall surface of the damper chamber comprises a peripheral inner-wall surface that is configured to be opposed to a tip end edge of the damper flap with a fine clearance in the angular range between the fully closing position of the main flap and the predetermined opening angle, and be retreated toward an outer peripheral side of the damper chamber to be spaced apart from the tip end edge of the damper flap in an angular range larger than the predetermined opening angle to thereby form the communication passage.

3. The intake apparatus as claimed in claim 1, wherein the damper chamber has an opening through which the damper chamber is communicated with the intake passage in the one of the two intake ducts, and when the main flap is located in the fully opening position, the main flap closes the opening of the damper chamber.

4. The intake apparatus as claimed in claim 1, wherein the communication passage extends over a whole width of the damper flap which extends in a direction parallel to the rotation axis.

5. The intake apparatus as claimed in claim 1, wherein the damper flap has a length extending in a direction perpendicular to the rotation axis which is shorter than a length of the main flap extending in the direction perpendicular to the rotation axis.

6. The intake apparatus as claimed in claim 2, wherein the peripheral inner-wall surface of the damper chamber comprises a partially cylindrical surface.

7. The intake apparatus as claimed in claim 2, wherein the peripheral inner-wall surface of the damper chamber comprises a first partially cylindrical surface and a second partially cylindrical surface having a diameter larger than that of the first partially cylindrical surface.
